(19) United States
(12) Patent Application Publication
(10) Pub. No.: US 2009/0106160 A1
(43) Pub. Date: Apr. 23, 2009

(54) AUTHORIZATIONS FOR MOBILE CONTACTLESS PAYMENT TRANSACTIONS

(75) Inventor: Dan Skowronek, Parker, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/875,103

(22) Filed: Oct. 19, 2007

(51) Int. Cl. G06Q 20/00; G06F 19/00; H04L 9/00

(52) U.S. Cl. 705/75

(57) ABSTRACT

Embodiments generally relate to systems and methods for processing electronic payments for retail services and goods delivered by unattended retail device. In embodiments, an unattended retail device leverages a consumer's mobile appliance to send the transaction and payment information to an authorizing authority. The authorizing authority receives the payment and transaction information, authorizes or declines the payment of the transaction, and forwards the authorization or declination to the mobile appliance. The mobile appliance then sends the authorization or declination to the unattended retail device. If authorized, the unattended retail device provides the retail good or service.

### BACKGROUND

This invention relates, in general, to electronic payment for retail service and, more specifically, but not by way of limitation, to contactless payments for a retail service that an unattended retail device provides.

An unattended retail device is a device that provides a retail service or product without the assistance of a person. For example, a vending machine and a parking meter are unattended retail devices. Customers can obtain a retail good or service from the unattended retail device after remitting payment to the device. Payment can be an exchange of cash money.

Some recent advances have allowed consumers to pay the unattended retail device for retail services or goods with an electronic payment from a credit or debit account. The unattended retail device can receive payment information from the consumer and send the information to an authorizing authority to approve the transaction and/or the payment. After receiving the authorization, the unattended retail device provides the service or good. However, not all unattended retail devices have access to a communication infrastructure allowing the device to send the payment and transaction information to an authorizing authority. As such, the widespread use of electronic payment to unattended retail devices is limited.

It is in view of these and other considerations not mentioned herein that the embodiments of the present disclosure were envisioned.

### BRIEF DESCRIPTION OF THE DRAWINGS

The present disclosure is described in conjunction with the appended figures:

FIG. 1 is a block diagram of an embodiment of a system operable to authorize contactless payments between a consumer and an unattended retail device;

FIG. 2A is a hardware and/or software block diagram of an embodiment of a mobile appliance for use in a system for authorizing contactless payment;

FIG. 2B is a set of hardware and/or software block diagrams of embodiments of an unattended retail device and a merchant processor for use in a system for authorizing contactless payment;

FIGS. 3A-E are block diagrams of embodiments of one or more data structures for communicating transaction and/or payment information in a system for authorizing contactless payment;

FIG. 4 is a flow diagram of an embodiment of a process for authorizing contactless payment executed at an unattended retail device;

FIGS. 5A-B are flow diagrams of an embodiment of a process for authorizing contactless payment executed at a mobile appliance;

FIG. 6 is a flow diagram of an embodiment of a process for authorizing contactless payment executed at a merchant processor;

FIG. 7 is a flow diagram of an embodiment of a process for authorizing contactless payment executed between a merchant processor and an issuing institution;

FIG. 8 is a block diagram of an embodiment of a computer system for use in the system for authorizing contactless payments.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

Embodiments of the disclosure generally relate to systems and methods for processing electronic payments for retail services and goods delivered by an unattended retail device. In embodiments, an unattended retail device leverages a consumer's mobile appliance to send the transaction and payment information to a merchant processing authority. The merchant payment processing authority (“merchant processor”) then sends the transaction and payment information on to a consumer payment authorizing authority. The consumer payment authorizing authority receives the payment and transaction information, authorizes or declines the payment of the transaction, and forwards the authorization or declination to the merchant payment processing authority. The merchant payment processing authority then forwards the authorization or declination to the mobile appliance. The mobile appliance then sends the authorization or declination to the unattended retail device. If authorized, the unattended retail device provides the retail good or service. The payments may be referred to as “contactless” payments. “Contactless” payment is a term of art meaning the there is no physical contact between a payment token and the retailing device, unlike the physical contact required to use a magnetic-stripe card. The transaction process is novel in that the unattended retail device does not have connectivity to the merchant processor except by relaying information through a consumer's mobile appliance.

Specific details are given in the following description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments. In some embodiments, a computing system may be used to execute any of the tasks or operations described herein. In embodiments, a computing system includes memory and a processor and is operable to execute computer-executable instructions stored on a computer readable medium that define processes or operations describe herein.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to, portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium such as storage medium. A processor(s) may perform the necessary tasks. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

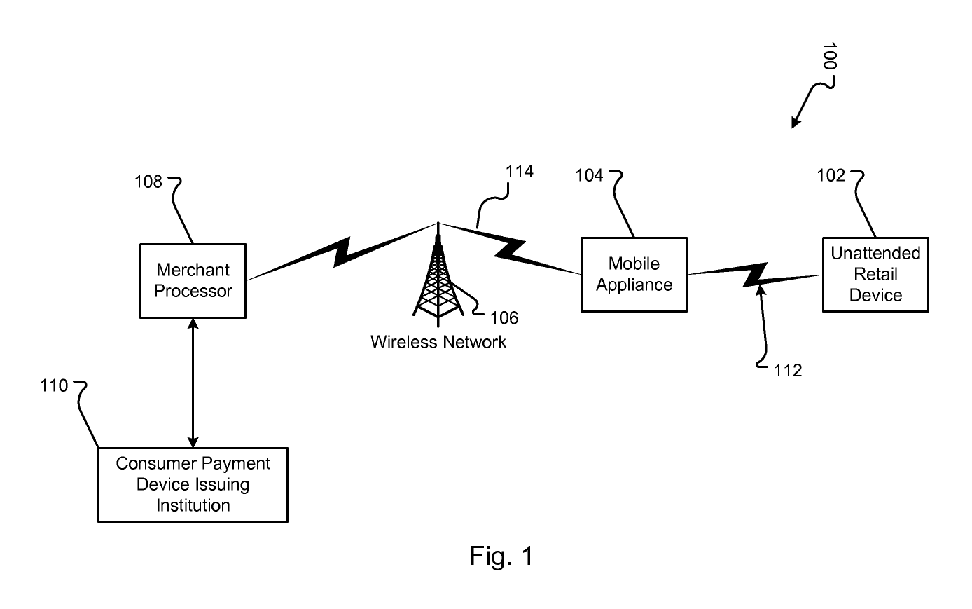

An embodiment of a system 100 for providing electronic payment for a retail service or good from an unattended retail device 102 is shown in FIG. 1. An unattended retail device 102 is a system or device that provides a retail service or good without assistance from a person. For example, a parking meter, a vending machine, etc. are examples of unattended retail devices 102. In embodiments, the unattended retail device 102 is operable to communicate with a mobile appliance 104 using a first communications channel 112. The unattended retail device 102, in embodiments, has no other means of communication besides the first communications channel 112.

The first communications channel 112 provides communications between the mobile appliance 104 and retail device 102. The first communications channel 112 may be any type of communications system including wireless, wired, or other communication system. In one embodiment, the first communications channel 112 is a wireless communication channel, and, in some embodiments, is near field communications (NFC) compliant. If a wireless communication channel, the first communication channel can be Bluetooth®, 802.11g, or other wireless system.

The mobile appliance 104, in embodiments, is a consumer's mobile appliance. The mobile appliance 104 is operable to receive communications from and send communications to the unattended retail device 102. Further, the mobile appliance 104 is operable to receive communications from and send communications to a merchant processor 108. In embodiments, the mobile appliance 104 communicates with the merchant processor 108 over a communications channel. The communications channel may be wireless and the mobile appliance 104 communicates using a wireless network 106. The mobile appliance 104 may be a mobile phone, cellular device, personal digital assistant with communication capability, etc. In alternative embodiments, one or more portions of the communications channel between the mobile appliance 104 and the merchant processor 108 includes wired media, for example, a LAN, WAN, the Internet, a telephone system, etc.

In embodiments, the system 100 includes a wireless network 106. The wireless network 106 provides a second communications channel 114. The second communications channel 114 allows the mobile appliance 104 to communicate with a merchant processor 108, which may be located in a distant area. For example, the mobile appliance 104 communicates with the merchant processor 108, which is located in another state or country. The wireless network 106 may be a cellular network, a wireless LAN or WAN, or other communication system. In other embodiments, the wireless network 106 includes one or more wired transmissions where at least a portion of the communication is via wired media.

The merchant processor 108, in embodiments, is a merchant acquirer or other entity that processes credit or debit authorizations on behalf of a merchant desiring to accept payment from network based payment systems such as credit, debit, stored value, etc. The merchant processor 108 may communicate authorization requests and receive authorizations or declinations of payment for a merchant over a payment network (e.g., VISA® or MASTERCARD®). In other embodiments, the merchant processor 108 may be a function of a financial institution, for example, a bank, that processes credit or debit authorization requests without a separate outside entity. The merchant processor 108 may have a predefined relationship with the institution that operated the unattended retail device 102 or, in some embodiments, with the consumer that owned the mobile appliance 104. In embodiments, a merchant processor 108 sends an authorization request to a consumer payment issuing institution 110. The consumer payment issuing institution 110, in embodiments, is a financial institution that approves transactions for a consumer and sends authorizations to the merchant processor 108.

In operation, a consumer may select a service or good provided by the unattended retail device 102. For example, the consumer selects a soda from a vending machine. The unattended retail device 102, in embodiments, requires payment. In an embodiment, the consumer uses his or her mobile appliance 104 to start a credit or debit transaction. In an alternative embodiment, the unattended retail device 102 begins the transaction. The consumer, in embodiments, starts a mobile application on the mobile appliance 104, which then sends a signal to the unattended retail device 102 by the first communications channel 112 to start the credit or debit transaction. The unattended retail device 104 compiles transaction information. In embodiments, transaction information may be the good or service requested, the amount of payment required, an identifier for the unattended retail device 102, an identifier for the merchant that needs to approve the transaction, instructions for the mobile appliance 104 to contact the merchant processor, and/or one or more other items of information. The transaction information is compiled into a packet of information for transfer over the first communications channel 112 to the mobile appliance 104. In embodiments, the packet of transaction information is encrypted for transmission. The unattended retail device 102 sends the transaction information to the mobile appliance 104. In embodiments, one or more items of the transaction information is also sent to the mobile appliance 104 in an unencrypted transmission.

The mobile appliance 104 receives the transaction information. In embodiments, the transaction information is presented to the consumer on the mobile appliance 104 for approval. If approved, the consumer selects a type of payment. For example, the consumer uses an “ewallet” application having a predetermined payment account or the consumer selects a credit card account or debit card account. An ewallet application, in embodiments, is an application that allows a user to use his or her credit and/or debit accounts electronically without presenting the card. The mobile appliance 104 compiles and appends the payment information to the transaction information received from the unattended retail device 102. The combined information is, in embodiments, encrypted and sent to the merchant processor 108. In embodiments, one or more items of the transaction and payment information may also be sent to the merchant processor 104 in an unencrypted transmission.

The merchant processor 108 receives the payment and transaction information. In embodiments, the merchant processor 108 compares one or more items of information in both the payment and transaction information to validate the authenticity of the transaction. The merchant processor 108 may then send an authorization request to the consumer payment issuing institution 110 to approve the transaction by determining the consumer can pay for the transaction. The consumer payment issuing institution 110 may then issue an authorization to the merchant processor 108. In embodiments, the merchant processor 108 sends the authorization to the mobile appliance 104, which forwards the authorization to the unattended retail device 102.

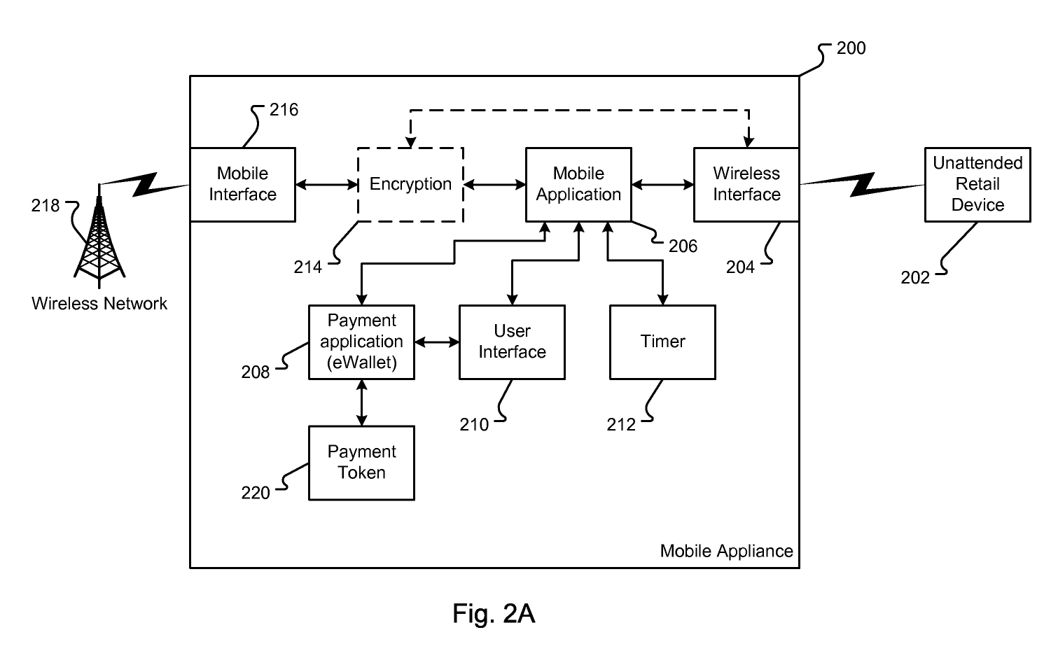

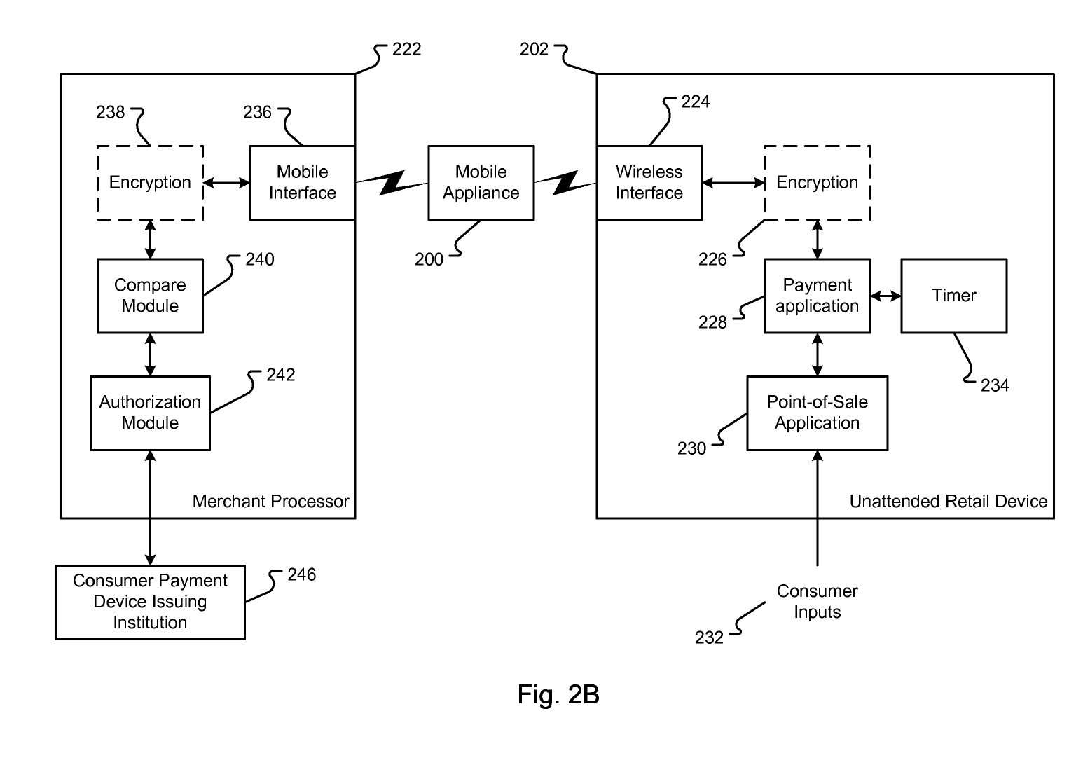

An embodiment of a consumer's mobile appliance 200 is shown in FIG. 2A. In embodiments, the mobile appliance 200 is the same or similar to the mobile appliance 104 (FIG. 1). The mobile appliance 200 comprises one or more of a wireless interface 204, a mobile application 206, an encryption module and/or system 214, a mobile interface 216, a timer 212, a user interface 210, a payment application 208, and/or a payment token 220. The wireless interface 204 is a software and/or system that can communicate with the unattended retail device 202. The wireless interface 204, in embodiments, is an NFC compliant interface, which may be Bluetooth, infrared, ultraviolet, 802.11g, or other technology.

The encryption module 214, in embodiments, encrypts and/or decrypts communications sent from the mobile appliance 200 or received by the mobile appliance 200. The encryption module 214 may use any encryption method, such as, symmetrical or asymmetrical encryption, public key encryption, PGP or other encryption method that is used by the unattended retail device 202 and/or the merchant processor 108 (FIG. 1). In embodiments, the encryption module 214 is optional as represented by the dashed lines.

The mobile appliance 200 further comprises a mobile interface 216, which is operable to communicate with the merchant processor 108 (FIG. 1). The mobile interface 216 may be any technology or system that can complete communications with the merchant processor 108 (FIG. 1), such as CDMA, TDMA, GSM, or other cellular technology used by the wireless network 218. In alternative embodiments, the mobile interface 216 is a module or system to communicate over a wireless LAN or WAN.

The user interface 210, in embodiments, is a display and/or a device or system to receive user inputs. For example, the display is an LCD or plasma screen and includes a keyboard or touch screen to receive user inputs. The timer 212 provides a clock for the mobile application 206. The timer may count indefinitely, wherein the mobile application 206 determines differences between two moments in time. In alternative embodiments, the timer 212 executes as a clock that increments to a predetermined number. For example, the timer 212 counts down from 180 seconds to zero seconds or counts up from zero seconds to 180 seconds.

The payment application or “eWallet” application 208 allows a user to pay for retail services using the mobile appliance 200 by electronically providing payment information. The payment information, in embodiments, includes a credit card number, a debit card number, a PIN, an account number, a password, payer authentication information, or other information required to pay for a retail service or good. The information about the consumer's accounts may be in the form of a payment token 220, which is a data structure that stores the consumer's information. The payment applicant 208 can access the payment token 220 to obtain information about one or more user accounts. The payment application 208, in embodiments, interacts with the user interface 210 to allow the user to select which account or payment option the user desires. In an alternative embodiment, a predetermined payment account is designated for all transactions, and the user need not select a payment option. The payment application 208 can then compile payment information that can be forwarded to the merchant processor 108 (FIG. 1).

In embodiments, the mobile appliance 200 also comprises a mobile application 206. The mobile application 206 is either hardware, software, or both hardware and software that assists the user in completing the transaction. The mobile application 206 receives the transaction information and provides the user interface 210 a display of the information for the user. The user can approve the transaction using the user interface 210. The mobile application 206 may then receive payment information from the payment application 208. In embodiments, the mobile application 206 combines the transaction information and the payment information into a communication sent to the merchant processor 108 (FIG. 1). The mobile application 206 may set the timer 212 and wait for a response. If the response fails to come before expiration of the timer 212, the mobile application 206 can cancel the transaction. If a decline message is received, the mobile application 206 may forward the decline message to the retail device 202 and/or cancel the transaction. If the authorization message is received, the mobile application 206 can forward the authorization to the retail device to complete the transaction.

Embodiments of an unattended retail device 202 and a merchant processor 222 are shown in FIG. 2B. The unattended retail device 202 comprises one or more of a wireless interface 224, a point-of-sale application 230, an encryption module and/or system 226, a timer 234, and/or a payment application 228. The wireless interface 224 is a software and/or system that can communicate with a mobile appliance 200. The wireless interface 224, in embodiments, is an NFC compliant interface, which may be Bluetooth®, infrared, ultraviolet, 802.11g, or other technology.

The encryption module 226, in embodiments, encrypts and/or decrypts communications received from or sent to the mobile appliance 200. The encryption module 226 may use any encryption method, such as, symmetrical or asymmetrical encryption, public key encryption, PGP or other encryption method that is used by the unattended retail device 202 and/or the merchant processor 222. In embodiments, the encryption module 226 is optional as represented by the dashed lines.

The timer 234 provides a clock for the payment application 228. The timer 234 may count indefinitely, wherein the payment application 228 determines differences between two moments in time. In alternative embodiments, the timer 234 executes as a clock that increments to a predetermined number. For example, the timer 234 counts down from 180 seconds to zero seconds or counts up from zero seconds to 180 seconds.

The point-of-sale (POS) application 230 operates the displays and receives inputs from the consumer for retail services. For example, if the unattended retail device 202 is a vending machine, the POS module 230 receives consumer inputs 232, such as the selection for the soda or other item and passes the selection to the payment application. In alternative embodiments, the POS module 230 also determines which type of payment the consumer desires to use, such as cash, credit, debit, etc. The POS module 230 may then pass this payment selection to the payment application 228.

The payment application 228 is either hardware, software, or both hardware and software that completes the transaction for the unattended retail device 202. The payment application 228 receives the selection and possibly payment selection information from the POS module 230. In embodiments, the payment application 228 creates the transaction information into a communication sent over the wireless interface 224 to the mobile appliance 200. The payment application 228 may set the timer 234 and wait for a response. If the response fails to come before expiration of the timer 234, the payment application 228 can cancel the transaction. If a decline message is received, the payment application 228 may cancel the transaction. If the authorization message is received, the payment application 228 can instruct the POS module 230 to complete the transaction.

The merchant processor 222 comprises at least one of an encryption module and/or system 238, a mobile interface 236, a compare module 240, and/or a payment authorization application 242. The encryption module 238, in embodiments, encrypts and/or decrypts communications received from or sent to the mobile appliance 200. The encryption module 238 may use any encryption method, such as, symmetrical or asymmetrical encryption, public key encryption, pretty-good-privacy (PGP) or other encryption method that is used by the unattended retail device 202 and/or the mobile appliance 200. In embodiments, the encryption module 238 is optional as represented by the dashed lines.

The mobile interface 236 is operable to communicate with the mobile appliance 200. The mobile interface 236 may be any technology or system that can complete communications with the mobile appliance 200, such as CDMA, TDMA, GSM, or other cellular technology used by the wireless network 218 (FIG. 2A). In alternative embodiments, the mobile interface 236 is a module or system to communicate over a wireless LAN or WAN, a wired communications channel, for example, a LAN, a WAN, the Internet, etc.

The compare module 240, in embodiments, is a module that compares payment information in the information sent from the mobile appliance 200 with transaction information sent from the unattended retail device 202. The compared information may include one or more of, but is not limited to, the cost of the service or good selected, the type of item or service selected, the amount of services or goods selected, or the identifier of the unattended retail device 202. Thus, the compare module 240 is operable to extract this information from the communication from the mobile appliance 200 and compare the information to ensure the authenticity of the transaction. In alternative embodiments, the compare module 240 is part of the consumer payment issuing institution 246. If a compare is unsuccessful, a signal may be sent to the mobile appliance 200 and/or the unattended retail device 202 to cancel the transaction.

The authorization module 242 can receive a signal from the compare module 240 that the information in the transaction is validated. The authorization module 242 may then seek approval of the transaction, from the consumer payment issuing institution 246, using known debit card or credit card authorization techniques. In embodiments, the authorization module 242 creates receives authorization message that is sent to the mobile appliance 200 and/or the unattended retail device 202 to authorize the transaction. In alternative embodiments, the authorization module 242 verifies the transaction information sent from the unattended retail device 202 but sends both the transaction information and the payment information to the consumer payment issuing institution 246 to validate and to authorize the transaction.

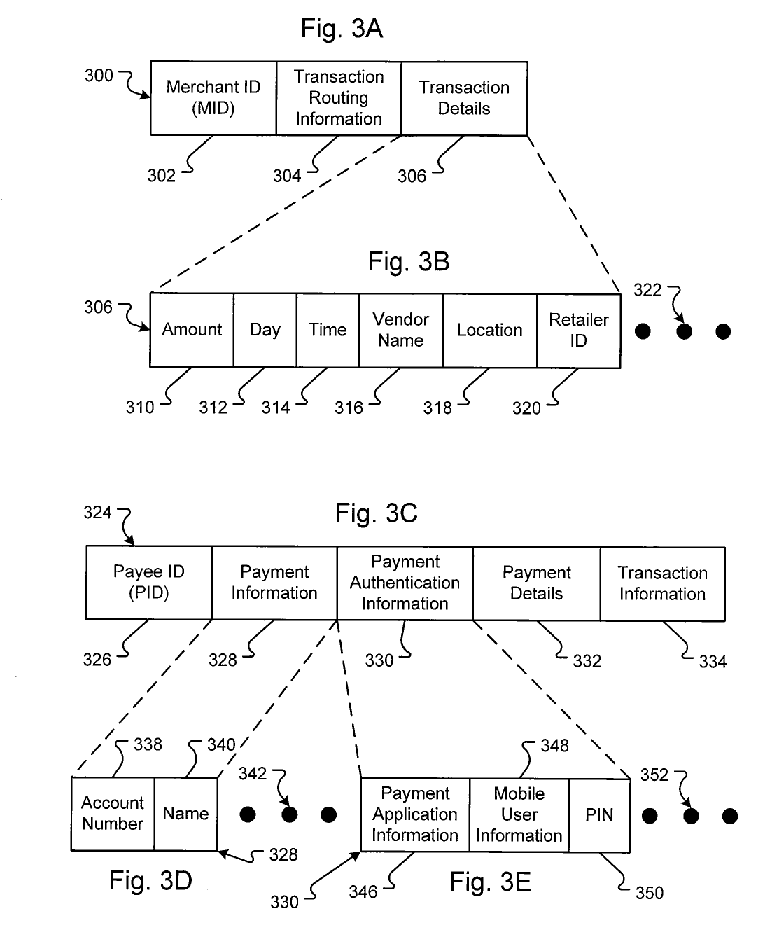

One or more data structures used to transport information between the unattended retail device 202 (FIG. 2B), the mobile appliance 200 (FIG. 2B), and the merchant processor 222 (FIG. 2B) is shown in FIGS. 3A-E. The one or more data structures, in embodiments, represent packets of information that are communicated using a communication protocol, such as TCP/IP or other protocol. As such, each packet of information may include a header that includes information necessary to transport the packet to the destination, for example, a routing address, encryption information, error codes, etc.

An embodiment of a data structure 300 for transporting transaction information from the unattended retail device 202 (FIG. 2B) to the mobile appliance 200 (FIG. 2B) is shown in FIG. 3A. The data structure 300, in embodiments, includes one or more fields, which may include, but are not limited to, a merchant identifier (MID) field 302, a transaction routing information field 304, and/or a transaction details field 306. The MID field 302 includes an identifier for the merchant processor 222 (FIG. 2B) that will receive the transaction information 300. The MID 302 may include a globally unique identifier (GUID) or other identifier that allows the mobile appliance 200 (FIG. 2B) and the unattended retail device 202 (FIG. 2B) to recognize where the transaction information is destined to be sent. The transaction routing information 304 includes information for the mobile appliance 200 (FIG. 2B) that allows the mobile appliance 200 (FIG. 2B) to route the data structure 300, also referred to as transaction information 300, and the payment information to the merchant processor 222 (FIG. 2B). In embodiments, the transaction routing information 304 includes a web or internet address for the merchant processor 222 (FIG. 2B). In an alternative embodiment, the transaction routing information 304 includes a direct dial interface. The MID 302 and the transaction routing information 304, in embodiments, is not encrypted or is encrypted and decrypted by the mobile appliance 200 (FIG. 2B).

The transaction details field 306 includes one or more fields containing information about the transaction as shown in FIG. 3B. In embodiments, the transaction details 306 includes at least one of, but is not limited to (as represented by the ellipses 322), an amount field 310, a day field 312, a time field 314, a vendor name field 316, a location field 318, and/or a retailer identifier (RID) field 320. The amount field 310 includes the amount that needs to be paid to complete the transaction. The day field 312 includes the day the transaction occurred. The time field 314 includes the time the transaction occurred. The vendor name field 316 includes the name of the vendor that owns or operates the unattended retail device 202 (FIG. 2B). For example, the vendor name may be the name of the city that is operating the parking meter. The location field 318 includes the location of the unattended retail device 202 (FIG. 2B) and/or the transaction. For example, the location field 318 includes the street address (e.g., 1993 Elm St., Potsdam, N.Y.) where the parking meter is located. The RID field 320 provides an identifier for the retailer or vendor that owns or operates the unattended retail device 202 (FIG. 2B). The RID may be a GUID or other identifier that uniquely identifies the vendor. Alternative embodiments of the transaction details 306 include product details, which may comprise the products selected, the number of products selected, the type of products select, the price of each product, etc. The product detail may be used to validate the transaction at the merchant processor 222 (FIG. 2B) or to provide transaction level details to the consumer or other appropriate and authorized parties.

In embodiments, the transaction details 306 are encrypted and cannot be decrypted by the mobile appliance 200 (FIG. 2B). As such, the transaction details 306 are preserved without tampering to allow the merchant processor 222 (FIG. 2B) to compare the information in the transaction details 306 to the payment information. In alternative embodiments, the transaction details 306 include one or more unencrypted items that allow the mobile appliance 200 (FIG. 2B) to verify the transaction. In still other embodiments, the transaction details 306 include both encrypted and unencrypted copies of portions of the transaction details 306.

In embodiments, a data structure 324 for communicating combined payment information and transaction information from the mobile appliance 200 (FIG. 2B) to the merchant processor 222 (FIG. 2B) is shown in FIG. 3C. Embodiments of the data structure 324 comprise one or more of, but is not limited to, a payee identifier (PID) 326, a payment information field 328, a payment authentication information field 330, a payment details field 332, and/or a transaction information field 334. The transaction information field 334 may include one or more items in the transaction information data structure 300 and may be encrypted. The PID 326 is an identifier for the consumer or the payment instrument (e.g., credit card, debit card, etc.) that the consumer is using. In embodiments, the PID 326 is a GUID or other unique identifier.

Payment information 328 can include information about the payment instrument selected by the consumer. In embodiments, payment information 328 includes one or more of, but is not limited to (as represented by the ellipses 342), an account number field 338 and/or a name field 340 as shown in FIG. 3D. The account number field 338 may include the credit card number, debit card number, or other identifier for the account or financial instrument used by the consumer. The name field 340, in embodiments, includes the consumer's name which is associated with the account being used.

Payment authentication information 330 includes information to verify the consumer using the account for payment is authorized to use the account. In embodiments, the payment authentication information 330 includes one or more of, but is not limited to (as represented by the ellipses 352), a payment application information field 346, a mobile user information field 348, and/or a PIN field 350. The payment application information field 346, in embodiments, includes information about the mobile application 206 (FIG. 2A) used by the consumer on the mobile appliance 200 (FIG. 2A). For example, the payment application information field 346 includes the name of the mobile application 206 (FIG. 2A), the version of the mobile application 206 (FIG. 2A), and/or and identifier for the mobile application 206 (FIG. 2A). The mobile user information field 348 can include one or more items of information identifying the consumer's mobile appliance, identifying the consumer's mobile phone account, or identifying the consumer using the mobile phone. For example, the mobile user information field 348 may include the consumer's cellular phone number and/or the consumer's mobile phone account number. The PIN field 350, in embodiments, includes the security PIN for the account listed in the payment information 328. In other embodiments, the PIN 350 is created automatically or manually for each transaction to verify the authenticity of the transaction. For example, the PIN 350 may be an encoded time stamp or other created identifier.

In embodiments, the payment details 332 includes one or more of the same information in the transaction details 308. The payment details 332 allow the merchant processor 222 (FIG. 2B) to compare information with the transaction details 308. As with the transaction information 334, the payment information 324 may be encrypted. As such, the payment details 332 are preserved without tampering to allow the merchant processor 222 (FIG. 2B) to compare the information in the transaction details 306 to the payment information 332. In alternative embodiments, the payment information 324 includes one or more unencrypted items that allow the merchant processor 222 (FIG. 2B) to verify the transaction. In still other embodiments, the payment information 324 includes both encrypted and unencrypted copies of the payment details 332.

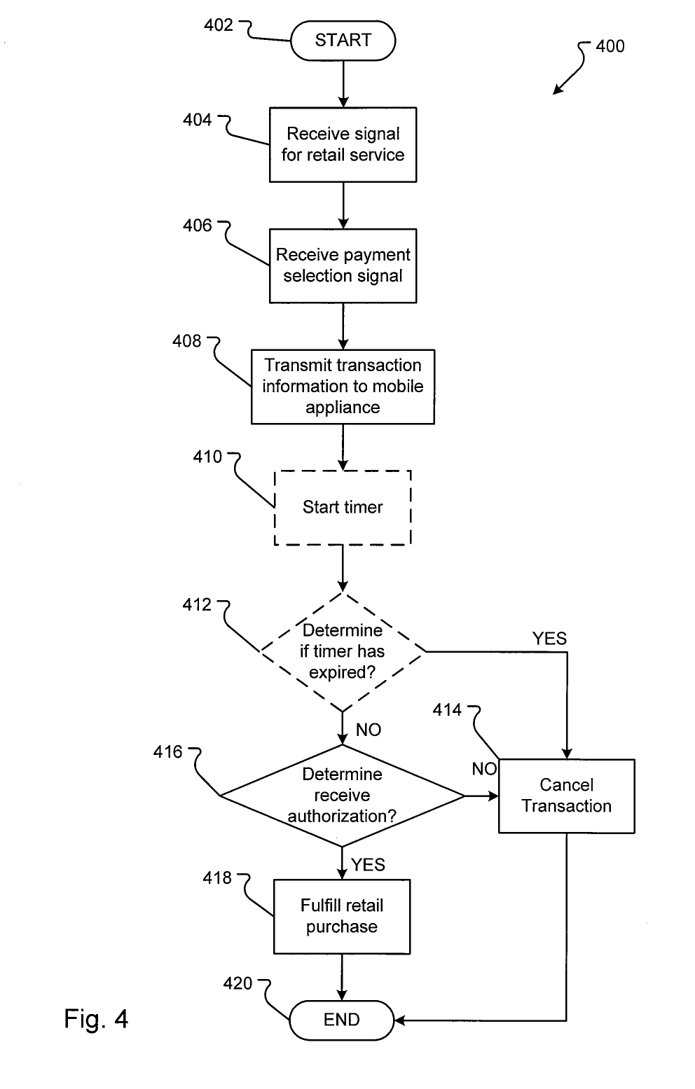

An embodiment of a method 400 executed at an unattended retail device 202 (FIG. 2B) for processing a “contactless” transaction is shown in FIG. 4. The transaction is “contactless” in that the unattended retail device 202 (FIG. 2B) does not have connectivity to the merchant processor except by relaying information through a consumer's mobile appliance 104 (FIG. 1). In embodiments, the method 400 generally begins with a START operation 402 and terminates with an END operation 420. The steps shown in the method 400 may be executed in a computer system as a set of computer-executable instructions. While a logical order is shown in FIG. 4, the steps shown or described can, in some circumstances, be executed in a different order than presented herein.

Receive operation 404 receives a signal for a retail service or good. In embodiments, a consumer selects one or more items or services to purchase. The selection is sent to the point-of-sale application 230 (FIG. 2B) of the unattended retail device 202 (FIG. 2B) as consumer input 232 (FIG. 2B). The point-of-sale application 230 (FIG. 2B) receives the selection as the signal for a retail service.

Receive operation 406 receives a payment selection signal. The point-of-sale application 230 (FIG. 2B) responds to the selection signal by acquiring what payment method the consumer desires to use, e.g., cash or credit. For example, the point-of-sale application 230 (FIG. 2B) displays a message to the consumer on the unattended retail device 202 (FIG. 2B) that asks for a payment selection. The consumer uses a user interface on the unattended retail device 202 (FIG. 2B) to select the payment type, which is another consumer input 232 (FIG. 2B), that the point-of-sale application 230 (FIG. 2B) receives. In embodiments, the consumer selects a payment type using an eWallet 208 (FIG. 2A) or other credit or debit account or system.

Transmit operation 408 transmits transaction information to the mobile appliance. In embodiments, after receiving the payment selection, the payment application 228 (FIG. 2B) compiles the transaction information from the point-of-sale application 230 (FIG. 2B) and/or one or more other sources into a data packet 300 (FIG. 3). The transaction information may include one or more items shown in data packet 300 (FIG. 3A). In embodiments, the payment application 228 (FIG. 2B) has one or more portions of the data packet 300 (FIG. 3A) encrypted by the encryption module 226 (FIG. 2B). The data packet 300 (FIG. 3A) is then forwarded to the wireless interface 224 (FIG. 2B), which transmits the data packet 300 (FIG. 3A) to the mobile appliance 200 (FIG. 2B).

Optional start operation 410 starts a timer. In some embodiments, the payment application 228 (FIG. 2B) starts the timer 234 (FIG. 2B) at the time that the data packet 300 (FIG. 3A) is transmitted to the mobile appliance 200 (FIG. 2B). As explained with FIGS. 2A and 2B, the timer 234 (FIG. 2B) may count down for a predetermined amount of time, for example, 180 seconds.

Optional determine operation 412 determines if the timer has expired. In embodiments, the payment application 228 (FIG. 2B) monitors the timer 234 (FIG. 2B). If the timer 234 (FIG. 2B) reaches zero (0) or the predetermined amount of time, the method flows YES to cancel operation 414. If the payment application 228 (FIG. 2B) receives an authorization or decline message before the timer 234 (FIG. 2B) reaches zero (0) or the predetermined amount of time, the method flows NO to receive operation 416. Cancel operation 414 cancels the transaction. In embodiments, after the timer 234 (FIG. 2B) expires, the payment application 228 (FIG. 2B) cancels the transaction by signaling the point-of-sale application 230 (FIG. 2B) not to provide the retail service or good. The point-of-sale application 230 (FIG. 2B) may inform the consumer that the transaction was cancelled because of a time out. The use of the timer 234 (FIG. 2B) ensures that transactions are not maintained when communication difficulties prevent receipt of the authorization.

Determine operation 416 determines if the authorization has been received from the mobile appliance 200 (FIG. 2B). In embodiments, the mobile appliance 200 (FIG. 2B) forwards the authorization message from the merchant processor 222 (FIG. 2B) to the unattended retail device 202 (FIG. 2B). The authorization message may be decrypted by the encryption module 226 (FIG. 2B). If the authorization has been received, the method flows YES to fulfill operation 418, wherein, the payment application 228 (FIG. 2B) then interprets the authorization message as allowing the transaction and sends a signal to the point-of-sale application 230 (FIG. 2B) to dispense the retail good(s) or provide the retail service(s). If the authorization has not been received, the method flows NO to cancel operation 414.

In an alternative embodiment, the unattended retail device 202 (FIG. 2B) receives a decline message, which means that the consumer payment processor (issuer) (FIG. 2B) did not approve the transaction. The decline message may be decrypted by the encryption module 226 (FIG. 2B). The decline message is interpreted as not receiving the authorization and the method flows NO to cancel operation 414. The method 400 then flows to cancel operation 414 and the payment application 228 (FIG. 2B) sends a signal to the point-of-sale application 230 (FIG. 2B) not to dispense the retail good(s) or not to provide the retail service(s). If the good(s) or service(s) are not provided, the point-of-sale application 230 (FIG. 2B) may inform the consumer that the transaction was declined.

Fulfill operation 418 fulfills the request for the good(s) or service(s). In embodiments, the point-of-sale application 230 (FIG. 2B) responds to the authorization signal from the payment application 228 (FIG. 2B) by providing the good(s) or service(s).

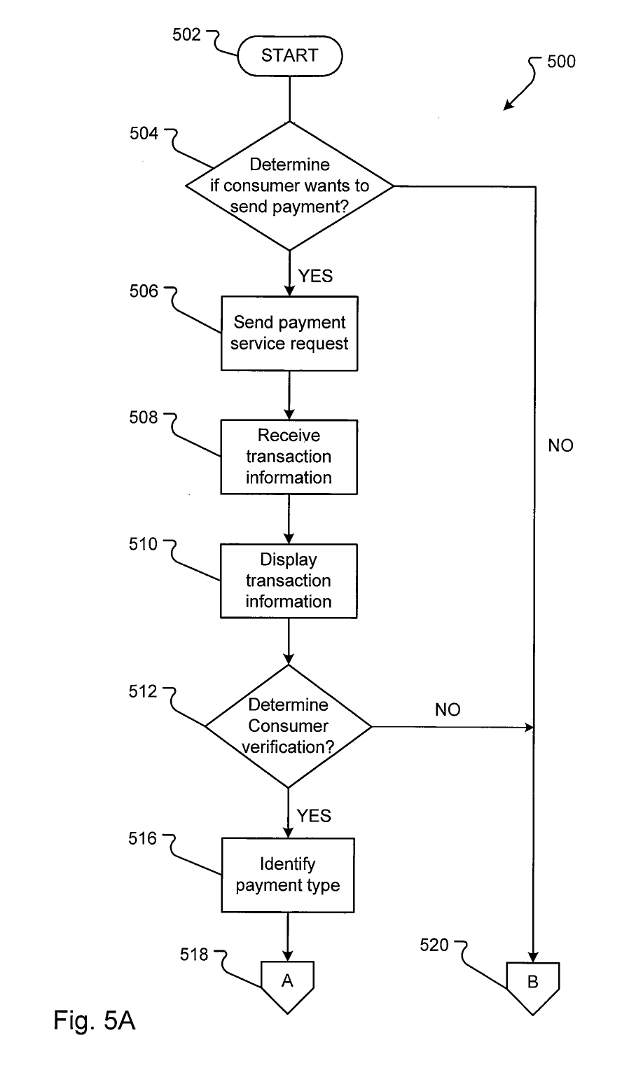

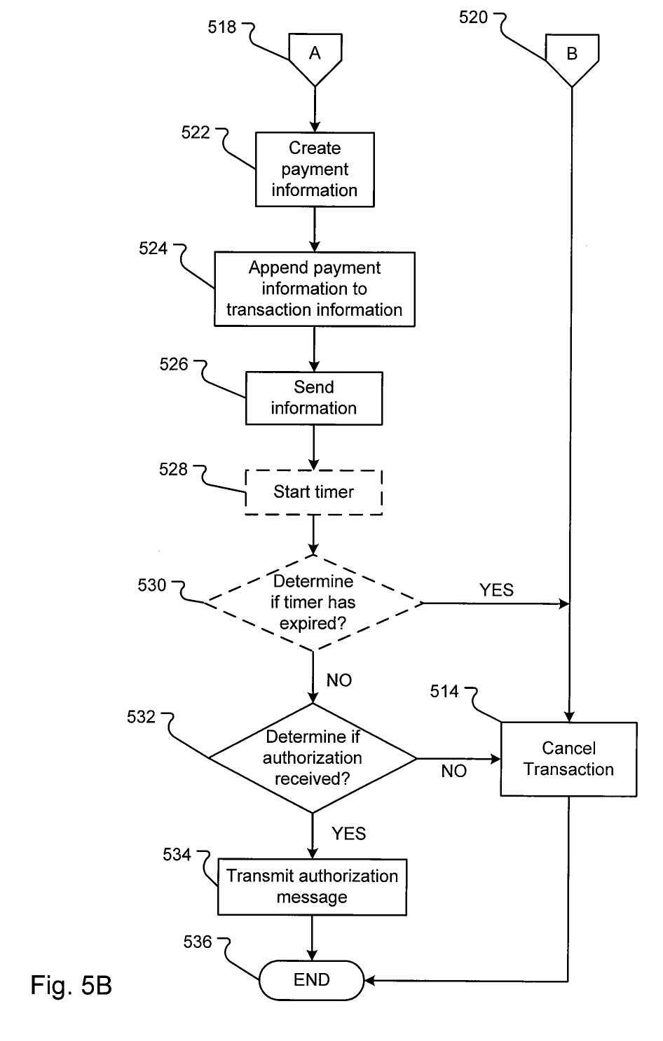

An embodiment of a method 500 executed at a mobile appliance 200 (FIG. 2A) for processing contactless transactions is shown in FIG. 5A and FIG. 5B. In embodiments, the method 500 generally begins with a START operation 502 and terminates with an END operation 536. The steps shown in the method 500 may be executed in a computer system as a set of computer-executable instructions. While a logical order is shown in FIG. 5, the steps shown or described can, in some circumstances, be executed in a different order than presented herein. Page connector A 518 and connector B 520 continue the flow of the method 500 from FIG. 5A to FIG. 5B.

Determine operation 504 determines if the user, which is the consumer, of the mobile appliance 200 (FIG. 2B) desires to send a payment. In embodiments, the consumer indicates to the point-of-sale application 230 (FIG. 2B) with consumer input 232 (FIG. 2B) that he or she desires to use a credit or debit account. The consumer may also use an eWallet application 208 to indicate to the payment application 228 (FIG. 2B) that the consumer desires to use a credit or debit account. For example, the consumer may simply hold the mobile appliance 200 (FIG. 2B) substantially near the unattended retail device 202 (FIG. 2B) to indicate that the consumer desires to use a credit or debit account. In other words, the eWallet application 208 automatically indicates to the payment application 228 (FIG. 2B) that a credit or debit account is to be used.

Send operation 506 sends a payment service request. In embodiments, the mobile appliance 200 (FIG. 2B) sends a signal to the payment application 228 (FIG. 2B) in the unattended retail device 202 (FIG. 2B) that payment by a credit or debit account is to be used. Receive operation 508 receives transaction information from the unattended retail device 202 (FIG. 2B). In embodiments, the wireless interface 204 (FIG. 2A) receives the transaction information packet 300 (FIG. 3A). One or more items of information in the transaction information packet 300 (FIG. 3A) may be encrypted and need decryption. The wireless interface 204 (FIG. 2A) can send the transaction information packet 300 (FIG. 3A) or portions thereof to the encryption module 214 (FIG. 2A) for decryption. In embodiments, one or more portions of the transaction information packet 300 (FIG. 3A) is not decrypted but sent to the merchant processor 222 (FIG. 2B) in an encrypted form. The decrypted portions of the transaction information packet 300 (FIG. 3A) are then sent to the mobile application 206 (FIG. 2A).

Display operation 510 displays one or more portions of the transaction information. In embodiments, the mobile appliance 200 (FIG. 2B) sends one or more portions of the transaction information to the user interface 210 (FIG. 2A). The user can view the transaction information on the user interface 210 (FIG. 2A). In embodiments, a user can verify or approve the transaction using the user interface 210 (FIG. 2A). For example, the user interface 210 (FIG. 2A) may display or include a button, icon, or other device, which, if selected by a user action, provides an approval signal to the mobile appliance 200 (FIG. 2A).

Determine operation 512 determines if the user verifies the transaction information. In embodiments, the mobile application 206 (FIG. 2A) determines if the user interface 210 (FIG. 2A) received the approval signal from user interaction with the user interface 210 (FIG. 2A). In other embodiments, the mobile application 206 (FIG. 2A) determines if the user interface 210 (FIG. 2A) received a decline signal from user interaction with another button, icon, or other device on the user interface 210 (FIG. 2A). If the user verifies the transaction information, the method 500 flows YES to receive operation 516. If the user does not verify the transaction information, the method 500 flows NO to cancel operation 514. Cancel operation 514 cancels the transaction. In embodiments, the mobile application 206 (FIG. 2A) cancels further processing of the transaction by the mobile appliance 200 (FIG. 2A) and sends a decline signal or message to the unattended retail device 202 (FIG. 2A). The method then flows through off-page connector B 520 to FIG. 5B where the method ends.

Receive operation 516 receives a payment type. In embodiments, the mobile application 206 (FIG. 2A) inquires of the payment application or eWallet 208 (FIG. 2A) which payment type the user desires. The payment type may be automatically selected. For example, a default payment is selected. In another embodiment, the payment application 208 (FIG. 2A), in embodiments, retrieves one or more items of information from the payment token 220 (FIG. 2A) and sends the information or a display for rendering to the user interface 210 (FIG. 2A). In other embodiments, the payment application 208 (FIG. 2A) automatically sends the information to the user interface 210 (FIG. 2A) without an inquiry from the mobile application 206 (FIG. 2A). The user interface 210 (FIG. 2A) can display the information and request the user to select a payment type. A payment type may be a selection of electronic account, electronic credit card account, electronic debit card account, stored value account, etc. The user interface 210 (FIG. 2A), in embodiments, receives the selection of payment type and signals the payment application 208 (FIG. 2A) which payment type has been selected. The method 500 then flows through off-page connector A 518 to FIG. 5B.

Create operation 522 creates payment information. In embodiments, the payment application 208 (FIG. 2A) reads one or more items of information from the payment token 220 (FIG. 2A) associated with the payment type selected by the user. The payment information in the payment token 220 (FIG. 2A) is sent to the mobile application 206 (FIG. 2A).

Append operation 524 appends the payment information to the transaction information. The mobile application 206 (FIG. 2A) creates a new data packet 324 (FIG. 3C), which includes transaction information 334 (FIG. 3C) that includes at least a portion of the transaction information 300 (FIG. 3A) received from the unattended retail device 202 (FIG. 2A). The new data packet 324 (FIG. 3C) also includes one or more portions of the payment information received from the payment application 208 (FIG. 2A). In embodiments, one or more portions of the new data packet 324 (FIG. 3C) may be sent to the encryption module 214 (FIG. 2A) to be encrypted.

Send operation 526 sends the appended payment information and transaction information. In embodiments, the mobile application 206 (FIG. 2A) forwards the new data packet 324 (FIG. 3C) to the mobile interface 216 (FIG. 2A) to send to the merchant processor 222 (FIG. 2B). The mobile interface 216 (FIG. 2A) can then transmit the new data packet 324 (FIG. 3C) over the wireless network 218 (FIG. 2A) bound for the merchant processor 222 (FIG. 2B). In alternative embodiments, the mobile application 206 (FIG. 2A) responds to a signal from the mobile interface 216 (FIG. 2A) that no signal is present for the wireless network 218 (FIG. 2A), that is, the new data packet 324 (FIG. 3) cannot be sent. The mobile application 206 (FIG. 2A) may then queue the new data packet 324 (FIG. 3) for later transmission or cancel the transaction.

Optional start operation 528 starts a timer. In some embodiments, the mobile application 206 (FIG. 2A) starts the timer 212 (FIG. 2A) at the time that the new data packet 324 (FIG. 3C) is transmitted to the merchant processor 222 (FIG. 2B). As explained with FIGS. 2A and 2B, the timer 212 (FIG. 2A) may count down for a predetermined amount of time, for example, 180 seconds.

Optional determine operation 530 determines if the timer has expired. In embodiments, the mobile application 206 (FIG. 2A) monitors the timer 212 (FIG. 2A). If the timer 212 (FIG. 2A) reaches zero (0) or the predetermined amount of time, the method flows YES to cancel operation 514. If the mobile application 206 (FIG. 2A) receives an authorization or decline message before the timer 212 (FIG. 2A) reaches zero (0) or the predetermined amount of time, the method flows NO to receive operation 532. Cancel operation 514 cancels the transaction. In embodiments, after the timer 212 (FIG. 2A) expires, the mobile application 206 (FIG. 2A) cancels the transaction by sending a decline message to the unattended retail device 202 (FIG. 2A) not to provide the retail service or good. The mobile application 206 (FIG. 2A) may also inform the consumer that the transaction was cancelled because of a time out by displaying a message in the user interface 210 (FIG. 2A). The use of the timer 212 (FIG. 2A) ensures that transactions are not maintained when communication difficulties prevent receipt of the authorization.

Determine operation 532 determines if the authorization has been received from the merchant processor 222 (FIG. 2B). In embodiments, the mobile appliance 200 (FIG. 2A) receives the authorization message from the merchant processor 222 (FIG. 2B). The authorization message may be encrypted. The mobile application 206 (FIG. 2A) may understand the message is an authorization and display an authorization indication in the user interface 210 (FIG. 2A). If the authorization is determined to have been received, the method flows YES to transmit operation 534. If the authorization is determined to have not been received, the method flows NO to cancel operation 514.

In an alternative embodiment, the mobile application 206 (FIG. 2A) receives a decline message, which means that the issuing institution 246 (FIG. 2B) did not approve the transaction. A decline message may be interpreted as not receiving an authorization. In an alternative embodiment, the mobile application 206 (FIG. 2A) receives a decline message if the merchant processor determines the encrypted and plain text information for the transaction information and the payment information do not match. The mobile application 206 (FIG. 2A) may interpret the decline message as not allowing the transaction and sends a signal to the user interface 210 (FIG. 2A) indicating that the transaction was not authorized.

Transmit operation 534 transmits the authorization to the unattended retail device 202 (FIG. 2A). In embodiments, the mobile application 206 (FIG. 2A) forwards the authorization to the wireless interface 204 (FIG. 2A). The authorization message may remain encrypted while being forwarded through the mobile application 206 (FIG. 2A). The wireless interface 204 (FIG. 2A) then transmits the authorization message to the unattended retail device 202 (FIG. 2A).

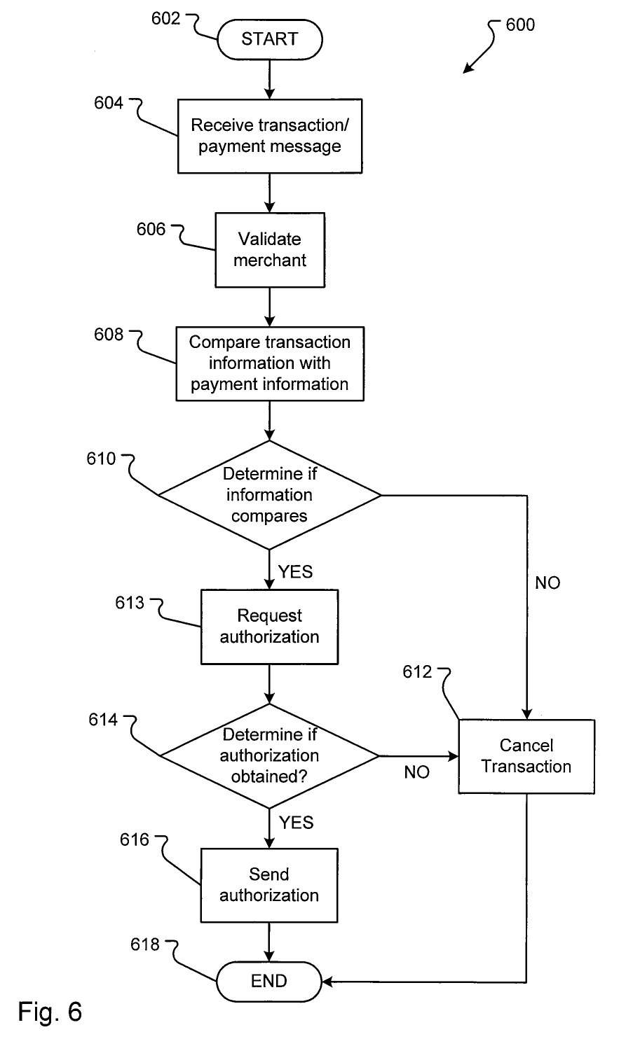

An embodiment of a method 600 executed at merchant processor 222 (FIG. 2B) for processing a contactless transaction is shown in FIG. 6. In embodiments, the method 600 generally begins with a START operation 602 and terminates with an END operation 618. The steps shown in the method 600 may be executed in a computer system as a set of computer-executable instructions. While a logical order is shown in FIG. 6, the steps shown or described can, in some circumstances, be executed in a different order than presented herein.

Receive operation 604 receives payment and transaction information from the mobile appliance 200 (FIG. 2B). In embodiments, the mobile interface 236 (FIG. 2B) receives the information packet 324 (FIG. 3C). One or more items of information in the information packet 324 (FIG. 3C) may be encrypted. The mobile interface 236 (FIG. 2B) can send the information packet 324 (FIG. 3C) or portions thereof to the encryption module 238 (FIG. 2B) for decryption. In embodiments, one or more portions of the information packet 324 (FIG. 3C) are not decrypted because the merchant processor 222 (FIG. 2B) does not contract with the consumer and, thus, does not have the keys or other information to decrypt the portions of the payment information. The decrypted portions of the information packet 324 (FIG. 3C) are then sent to the compare module 240 (FIG. 2B).

Validate operation 606 validates the merchant. The compare module 240 (FIG. 2B) first determines, using the MID 302 (FIG. 3A) or other information if the merchant owning the unattended retail device 202 (FIG. 2B) has contracted with the merchant processor 222 (FIG. 2B). If the merchant does not contract with the merchant processor 222 (FIG. 2B), the transaction may be cancelled. However, if the merchant does contract with the merchant processor 222 (FIG. 2B), the method flows to the compare operation 608.

Compare operation 608 compares one or more portions of the transaction information with one or more portions of the payment information. In embodiments, the compare module 240 (FIG. 2B) compares at least one item in the payment details 332 (FIG. 3C) with at least one item in the transaction details 308 (FIG. 3B). The information in the transaction details 308 (FIG. 3B) may have been encrypted such that only the merchant processor 222 (FIG. 2B) could decrypt the transaction details 308 (FIG. 3B). Thus, the consumer could not alter the data in the transaction details 308 (FIG. 3B) to create a fraudulently correct compare. The compare module 240 (FIG. 2B) may compare the items selected, the price of the transaction, the number of items selected, the MID, etc.

Determine operation 610 determines if the one or more items in the transaction details 308 (FIG. 3B) compares to the one or more items in the payment details 332 (FIG. 3C). In embodiments, the compare module 240 (FIG. 2B) makes the determination. If the one or more items do compare, the method flows YES to request operation 613. If the one or more items do not compare, the method flows NO to cancel operation 612. Cancel operation 612 cancels the transaction. In embodiments, the compare module 240 (FIG. 2B) sends a decline message to the mobile interface 236 (FIG. 2B) to forward to the mobile appliance 200 (FIG. 2B) and/or the unattended retail device 202 (FIG. 2B) to cancel the transaction.

Request operation 613 requests authorization for the transaction from the consumer payment processor (issuer) 246 (FIG. 2B). In embodiments, the authorization module 242 (FIG. 2B) of the merchant processor 222 (FIG. 2B) request authorization from the issuing institution 246 (FIG. 2B), which authorizes the transaction using known methods for approving credit card, debit card, or other account transactions. In embodiments, the merchant processor 222 (FIG. 2B) waits for the authorization from the issuing network, except in circumstances permitted by the issuing network, for example, a restaurant payment below $25. In other embodiments, the authorization module 242 (FIG. 2B) requests and receives approval for the transaction from a financial institution. If the transaction is not approved, the authorization module 242 (FIG. 2B) receives or generates a decline message.

Determine operation 614 determines if the authorization is obtained. In embodiments, the merchant processor 222 (FIG. 2B) receives the authorization message from the issuing institution 246 (FIG. 2B). The authorization message may be encrypted. The merchant processor 222 (FIG. 2B) may understand the message is an authorization and forward the authorization indication in the mobile appliance 202 (FIG. 2A). If the authorization is determined to have been received, the method flows YES to send operation 616. If the authorization is determined to have not been received, the method flows NO to cancel operation 612.

In an alternative embodiment, the mobile application 206 (FIG. 2A) receives a decline message, which means that the issuing institution 246 (FIG. 2B) did not approve the transaction. A decline message may be interpreted as not receiving an authorization. In an alternative embodiment, the merchant processor 222 (FIG. 2B) receives a decline message if the issuing institution 246 (FIG. 2B) determines the encrypted and plain text information for the transaction information and the payment information do not match. The merchant processor 222 (FIG. 2B) may interpret the decline message as not allowing the transaction and sends a signal to the mobile appliance 202 (FIG. 2B) indicating that the transaction was not authorized.

Send operation 616 sends the authorization. In embodiments, the authorization message processing module for the merchant processor 222 (FIG. 2B) sends the authorization to the mobile interface 236 (FIG. 2B). The mobile interface 236 (FIG. 2B) can transmit or send the authorization to the mobile appliance 200 (FIG. 2B), which may then forward the authorization or decline message to the unattended retail device 202 (FIG. 2B).

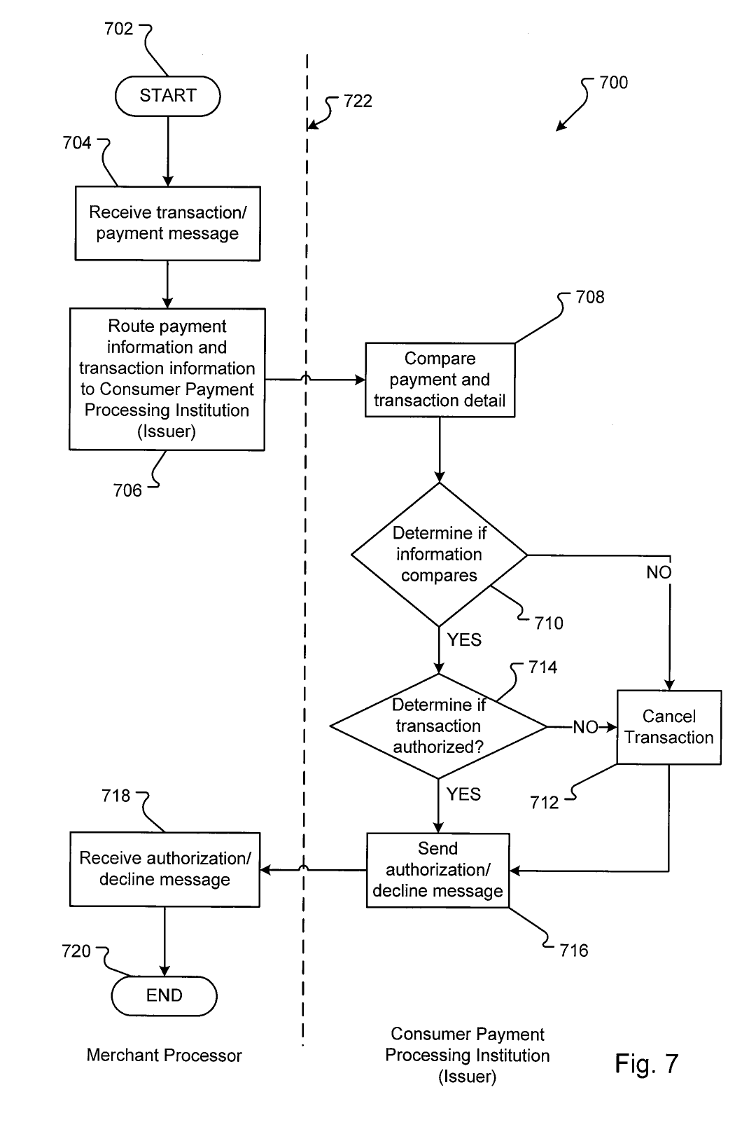

An embodiment of a method 700 executed at both a merchant processor 222 (FIG. 2B) and a consumer payment device issuing institution (“issuing institution”) 246 (FIG. 2B) for processing a contactless transaction shown in FIG. 7. Operations to the left of line 722 occur at the merchant processor 222 (FIG. 2B) while operations that are to the right of line 722 occur at the issuing institution 246 (FIG. 2B). In embodiments, the method 700 generally begins with a START operation 702 and terminates with an END operation 720. The steps shown in the method 700 may be executed in a computer system as a set of computer-executable instructions. While a logical order is shown in FIG. 7, the steps shown or described can, in some circumstances, be executed in a different order than presented herein.

Receive operation 704 receives payment and transaction information from the mobile appliance (FIG. 2B). In embodiments, the mobile interface 236 (FIG. 2B) receives the information packet 324 (FIG. 3). One or more items of information in the information packet 324 (FIG. 3) may be encrypted. The mobile interface 236 (FIG. 2B) can send the information packet 324 (FIG. 3) or portions thereof to the encryption module 238 (FIG. 2B) for decryption. In embodiments, one or more portions of the information packet 324 (FIG. 3) are not decrypted because the merchant processor 222 (FIG. 2B) does not contract with the consumer and, thus, does not have the keys or other information to decrypt the portions of the payment information. However, the encrypted portion of the information packet 324 (FIG. 3) can be decrypted by the issuing institution 246 (FIG. 2B), which has contracted with the consumer.

Route operation 706 routes the encrypted payment information and the transaction information, either encrypted or decrypted, to the issuing institution 246 (FIG. 2B). In embodiments, the merchant processor 222 (FIG. 2B) sends the information to the issuing institution 246 (FIG. 2B). The merchant processor 222 (FIG. 2B) may use any form of communication media, including, but not limited to, a LAN, WAN, Internet, or other system. The issuing institution 246 (FIG. 2B) receives the information and can decrypt any encrypted portions of the information that the merchant processor 222 (FIG. 2B) could not decrypt. The issuing institution 246 (FIG. 2B) then has at least portions of both the payment information and the transaction information that are decrypted.

Compare operation 708 compares one or more portions of the transaction information with one or more portions of the payment information at the issuing institution 246 (FIG. 2B). In embodiments, the issuing institution 246 (FIG. 2B) compares at least one item in the payment details 332 (FIG. 3C) with at least one item in the transaction details 308 (FIG. 3B). The information in the transaction details 308 (FIG. 3B) may have been encrypted such that only the merchant processor 222 (FIG. 2B) could decrypt the transaction details 308 (FIG. 3B) and the merchant processor 222 (FIG. 2B) forwards the transaction information to the issuing institution 246 (FIG. 2B) in an unencrypted form. The issuing institution 246 (FIG. 2B) may compare the items selected, the price of the transaction, the number of items selected, the MID, etc.

Determine operation 710 determines if the one or more items in the transaction details 308 (FIG. 3B) compares to the one or more items in the payment details 332 (FIG. 3C). In embodiments, the issuing institution 246 (FIG. 2B) makes the determination. If the one or more items do compare, the method flows YES to authorize operation 714. If the one or more items do not compare, the method flows NO to cancel operation 712. Cancel operation 712 cancels the transaction. In embodiments, the issuing institution 246 (FIG. 2B) sends a decline message to the merchant processor 222 (FIG. 2B) to forward to the mobile appliance 200 (FIG. 2B) and/or the unattended retail device 202 (FIG. 2B) to cancel the transaction, as explained in conjunction with send operation 716.

Determine operation 714 determines if the transaction is authorized. In embodiments, the issuing institution 246 (FIG. 2B) authorizes the transaction using known methods for approving credit card, debit card, or other account transactions. In other embodiments, the authorization module 242 (FIG. 2B) requests and receives approval for the transaction from another financial institution. If the transaction is not approved, the issuing institution 246 (FIG. 2B) generates a decline message. If the transaction is authorized, the method flows YES to send operation 716. If the transaction is not authorized, the method flows NO to cancel operation 716

Send operation 716 sends the authorization or decline message. In embodiments, the issuing institution 246 (FIG. 2B) sends the authorization or decline message to the merchant processor 222 (FIG. 2B). The issuing institution 246 (FIG. 2B) can transmit or send the authorization or decline message to the merchant processor 222 (FIG. 2B), which may then forward the authorization or decline message to the mobile appliance 200 (FIG. 2B) and/or the unattended retail device 202 (FIG. 2B).

Receive operation 718 receives authorization for the transaction at the merchant processor 222 (FIG. 2B). In embodiments, the authorization module 242 (FIG. 2B) of the merchant processor 222 (FIG. 2B) receives the authorization for the credit card, debit card, or other account transaction. In other embodiments, the authorization module 242 (FIG. 2B) receives a decline message.

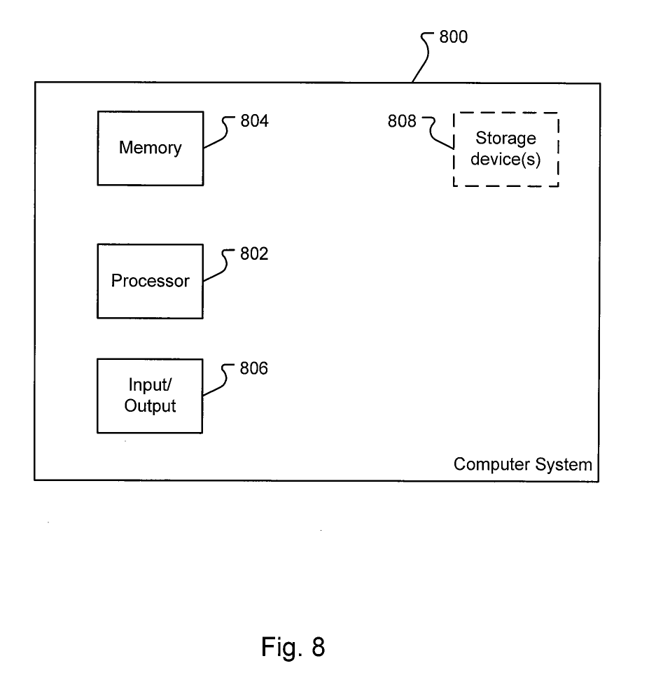

Embodiments of the different systems represented in this disclosure, which may include the merchant processor 222 (FIG. 2B), the mobile appliance 200 (FIG. 2A), the unattended retail device 202 (FIG. 2B), and/or the issuing institution 246 (FIG. 2B), may be a computer system, such as computer system 800 shown in FIG. 8. A basic computer system is shown as one skilled in the art will recognize the technical changes and modifications that may be required to make the systems described herein operable. The computer system 800 comprises a processor 802, which completes the operations described in conjunction with FIGS. 4 through 7 or makes the systems operable described in conjunction with FIGS. 1 through 2B. The processor 802 may be any type of processor operable to complete the operations or implement the systems described herein. For example, the processor 802 may be an Intel Pentium processor, an ASIC, an FPGA, or other device.

The computer system 800 also comprises memory 804 to hold data or code being executed by processor 802. The memory 804 may permanently or temporarily store the instructions described in conjunction with FIGS. 4 through 7 or the data elements described in conjunction with FIG. 3. Memory may be classified as computer readable medium, for example, RAM, ROM, magnetic media, optical media, etc.

The computer system 800 also can comprise software elements, including an operating system and/or other code, such as one or more application programs for authorizing contactless payments at any of the merchant processor 222 (FIG. 2B), the mobile appliance 200 (FIG. 2A), the unattended retail device 202 (FIG. 2B), and/or the issuing institution 246 (FIG. 2B). The application programs may comprise computer programs described herein, and/or may be designed to implement methods described herein and/or configure systems described herein. Merely by way of example, one or more procedures described with respect to the method(s) discussed in conjunction with FIGS. 4-7 might be implemented as code and/or instructions executable by the computer system 800 (and/or the processor 802 within the computer 800).

A set of these instructions and/or code might be stored on a computer readable storage medium, such as the storage device(s) 808 or memory 804. In some cases, the storage medium might be incorporated within a computer system. In other embodiments, the storage medium might be separate from a computer system (i.e., a removable medium, such as a compact disc, etc.), and or provided in an installation package, such that the storage medium can be used to program a general purpose computer with the instructions/code stored thereon. These instructions might take the form of executable code, which is executable by the computer system 800 and/or might take the form of source and/or installable code, which, upon compilation and/or installation on the computer system 800 (e.g., using any of a variety of generally available compilers, installation programs, compression/decompression utilities, etc.) then takes the form of executable code.

Further embodiments of the computer system 800 comprises input/output (I/O) modules of systems 806. I/O systems 806 may include displays such as LCDs, plasma screen, cathode ray tubes, etc. The displays can provide a visual representation of data to a user. I/O system 806 may also include input devices such as mice, keyboards, touch screens, etc. Input devices allow the user to input information into the computer system. I/O systems 806 may also comprise communication systems such as wired, wireless, or other communication systems. Further, communication systems may communicate with peripheral devices, such as printers, modems, or other devices.

In light of the above description, a number of advantages of the present invention are readily apparent. For example, the systems allow for transaction with unattended retail devices that have no direct path of connectivity to a merchant processor. Thus, a technical solution is provided of connecting through a consumer's mobile appliance using new hardware and/or software in the mobile appliance, unattended retail device, and/or merchant processor to effectuate the communication of information from the unattended retail device to the merchant processor. As such, no cellular or mobile transmitter is needed in each unattended retail device, which saves a great deal of expense for the merchant. Further, the unattended retail devices may be deployed in remote locations and still operate to receive credit or debit transactions. Still further, the unattended retail device leverages the consumer's mobile appliance to send the information needed to receive the credit or debit authorization. As such, the merchant saves the enormous expense of opening cellular phone accounts for each unattended retail device and sending numerous messages from each unattended retail device.

A number of variations and modifications of the invention can also be used. For example, the unattended retail device may interact with an appliance at a person's home that is not a mobile device. For example, a user could use an appliance similar in function to the mobile appliance to pay for a delivery pizza brought to the consumer's home. The consumer's appliance could pass through information to a merchant processor but simply use wired telephone technology. In another embodiment, the user could pass through information to a merchant processor using the web. For example, a merchant could send information to the consumer's computer, which could forward the information on to a merchant processor for authorization.

In still another embodiment, the system could effectuate person-to-person payments. For example, a first user could send a message, with transaction information, to a second user that he or she owes an amount of money. The second user could append this information to payment information and forward the combined information to the merchant processor. The merchant processor could forward the authorization back to the second user, which passes the authorization to the first user. The credit payment could happen then between the parties as a normal financial transaction.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

While the principles of the invention have been described above in connection with specific apparatuses and methods, it is to be clearly understood that this description is made only by way of example and not as limitation on the scope of the invention.

What is claimed is:

1. A consumer mobile appliance for completing a transaction with a retail device, the consumer mobile appliance comprising:
a first interface to a first wireless communications channel, the first interface to the first wireless communications channel operable to receive transaction information from the retail device, the first interface to the first wireless communications channel operable to send an authorization for the transaction to the retail device;
a first interface to a second communications channel, the first interface to the second communications channel operable to send the transaction information, from the retail device, and payment information to a merchant processor, the first interface to the second communications channel operable to receive the authorization for the transaction; and
a mobile application in communication with the first interface to the first wireless communication channel and the first interface to the second communication channel, the mobile application operable to generate the request for the transaction and provide the request to the first interface to the first communications channel, the mobile application operable to append the payment information to the transaction information, the mobile application operable to provide the payment information and transaction information to the first interface to the second communications channel, the mobile application operable to forward the authorization for the transaction from the first interface to the second communications channel to the first interface to the first communication channel.

2. The consumer mobile appliance as defined in claim 1, further comprising a payment application, the payment application operable to create the payment information and provide the payment information to the mobile application.

3. The consumer mobile appliance as defined in claim 2, wherein the payment application provides the payment information to a user interface for display, the user interface operable to display the payment information to a user.

4. The consumer mobile appliance as defined in claim 3, wherein the user interface is operable to receive a signal, the signal representing the user's acceptance of the payment information.

5. The consumer mobile appliance as defined in claim 1, further comprising a timer, the timer operable to operate for a predetermined period of time, the timer operable to send a signal to the mobile application after the predetermined period of time, wherein the mobile application cancels the transaction if the authorization has not been received before receiving the signal from the timer.

6. The consumer mobile appliance as defined in claim 1, wherein the mobile application is operable to provide the authorization to a user interface, the user interface displaying the authorization for a user.

7. The consumer mobile appliance as defined in claim 1, further comprising an encryption module, the encryption module operable to encrypt the appended payment information and transaction information before sending the payment information and transaction information to the merchant processor.

8. The consumer mobile appliance as defined in claim 1, wherein the retail device is a first person's mobile appliance and the transaction information relates to a person-to-person payment.

9. The consumer mobile appliance as defined in claim 1, wherein the retail device comprises:
a second interface to the first wireless communications channel, the second interface to the first wireless communications channel operable to receive the request for the transaction with the retail device, the second interface to the first wireless communications channel operable to send transaction information from the retail device, the first interface to the first wireless communications channel operable to receive the authorization for the transaction;
a point-of-sale application, the point-of-sale application operable to receive a selection for a retail service or good, the point-of-sale application operable to send information about the selection; and
a payment application in communication with the second interface to the first wireless communications channel and the point-of-sale application, the payment application operable to receive the information about the selection from the point-of-sale application, the payment application operable to create the transaction information and provide the transaction information to the second interface to the first wireless communications channel.

10. The consumer mobile appliance as defined in claim 1, wherein the merchant processor comprises:
a second interface to the second communications channel, the second interface to the second communications channel operable to receive the transaction information and the payment information, the second interface to the second communications channel operable to send the authorization for the transaction;
a compare module in communication with the second interface to the second communications channel, the compare module operable to compare one or more portions of the transaction information with one or more portions of the payment information to verify the transaction; and
an authorization module in communication with the second interface to the second communications channel and the compare module, the authorization module operable to obtain the authorization of the transaction and sending the authorization to the second interface to the second communications channel.

11. A method for authorizing a transaction with a retail device, the method comprising:
wirelessly sending a request for retail service from a mobile appliance to the retail device;
wirelessly receiving transaction information from the retail device;
creating payment information for the transaction;
appending the payment information to the transaction information;
wirelessly sending the appended payment information and transaction information to a merchant processor;
wirelessly receiving authorization for the transaction from the merchant processor; and
wirelessly sending the authorization to the retail device.

12. The method as defined in claim 11, further comprising:
displaying the transaction information for a user on a user interface device;
determining if the user accepts the transaction information by receiving a signal;
if the user accepts the transaction information, creating the payment information for the transaction; and
if the user does not accept the transaction information, cancelling the transaction.

13. The method as defined in claim 11, further comprising:
receiving a payment type; and
in response to receiving the payment type, creating the payment information for the transaction.

14. The method as defined in claim 13, further comprising
displaying the payment information for a user on a user interface device;
determining if the user accepts the payment information by receiving a signal;
if the user accepts the payment information, creating the payment information for the transaction; and
if the user does not accept the payment information, cancelling the transaction.

15. The method as defined in claim 11, further comprising:
wirelessly receiving the payment information and transaction information at the merchant processor;
comparing at least a portion of the payment information to at least a portion of the transaction information;
determining if the portion of the payment information compares to the portion of the transaction information;
if the portion of the payment information does not compare to the portion of the transaction information, wirelessly sending a decline message to the mobile appliance to cancel the transaction;
if the portion of the payment information compares to the portion of the transaction information, authorizing the payment; and
in response to authorizing the payment, wirelessly sending the authorization to the mobile appliance.

16. The method as defined in claim 15, further comprising:
wirelessly receiving the decline message at the mobile appliance; and
in response to receiving the decline message, cancelling the transaction.

17. The method as defined in claim 11, further comprising:
wirelessly receiving the payment information and transaction information at the merchant processor;
routing the payment information to a consumer payment device issuing institution;
comparing, by the consumer payment device issuing institution, at least a portion of the payment information to at least a portion of the transaction information;
determining, by the consumer payment device issuing institution, if the portion of the payment information compares to the portion of the transaction information;
if the portion of the payment information does not compare to the portion of the transaction information, sending a decline message to the merchant processor to cancel the transaction;
wirelessly sending the decline message from the merchant processor to the mobile appliance;
if the portion of the payment information compares to the portion of the transaction information, authorizing, by the issuing institution authorization, the transaction;
in response to authorizing the payment, sending the authorization to the merchant processor; and
wirelessly sending the authorization from the merchant processor to the mobile appliance.

18. A computer program stored on a computer readable medium, the computer program embodied in one or more instructions for authorizing a transaction at a retail device, the computer program comprising:
instructions to receive a request for a retail service;
instructions to transmit wirelessly transaction information from the retail device to a mobile appliance;
instructions to receive an authorization for the retail service; and
instructions to provide the retail service in response to the authorization.

19. The computer program as defined in claim 18, further comprising:
instructions to start a timer that operates for a predetermined period of time;
instructions to determine if the authorization has been received before the predetermined period of time; and
instructions to cancel the transaction if the authorization has not been received before the predetermined period of time.

20. The computer program as defined in claim 18, further comprising:
instructions to receive a signal declining the transaction for the retail service; and
instructions to cancel the transaction in response to the signal declining the transaction.
